(19) United States
(12) Patent Application Publication
(10) Pub. No.: US 2015/0379534 A1
(43) Pub. Date: Dec. 31, 2015

(54) Contact Engagement Analysis for Target Group Definition

(71) Applicants: Arnulf Schueler, Heidelberg (DE); Sven-Eric Eigemann, Sandhausen (DE); Thomas Maag, Reilingen (DE); Vytas Cirpus, Waldsee (DE); Daniel Jakobs, Ettlingen (DE); Martin Zielonkowski, Freinshein (DE); Huaiyang Mao, Schriesheim (DE); Dagmar Opitz, Sandhausen (DE); Shabana Ansari, Wiesloch (DE); Eduard Hess, Wiesloch (DE); Sonja Zscherpel, Muehlhausen (DE); Michael Rey, Speyer (DE); Andreas Bettin, Bad Schoenborn (DE); Stefan Nasshan, Romerberg (DE); Nicolae Ciumac, Karlsruhe (DE); Joerg Losat, Muehlhausen (DE); Joachim Woerner, Waldbronn (DE); Christian Clasani, Heidelberg (DE); Stefan Daum, Dielheim (DE); Michael Ohnemus, Wilhelmsfeld (DE); Rolf Schumann, Bad Schoenborn (DE)

(72) Inventors: Arnulf Schueler, Heidelberg (DE); Sven-Eric Eigemann, Sandhausen (DE); Thomas Maag, Reilingen (DE); Vytas Cirpus, Waldsee (DE); Daniel Jakobs, Ettlingen (DE); Martin Zielonkowski, Freinshein (DE); Huaiyang Mao, Schriesheim (DE); Dagmar Opitz, Sandhausen (DE); Shabana Ansari, Wiesloch (DE); Eduard Hess, Wiesloch (DE); Sonja Zscherpel, Muehlhausen (DE); Michael Rey, Speyer (DE); Andreas Bettin, Bad Schoenborn (DE); Stefan Nasshan, Romerberg (DE); Nicolae Ciumac, Karlsruhe (DE); Joerg Losat, Muehlhausen (DE); Joachim Woerner, Waldbronn (DE); Christian Clasani, Heidelberg (DE); Stefan Daum, Dielheim (DE); Michael Ohnemus, Wilhelmsfeld (DE); Rolf Schumann, Bad Schoenborn (DE)

(21) Appl. No.: 14/319,676

(22) Filed: Jun. 30, 2014

(51) Int. Cl. G06Q 30/02; G06F 3/0484; G06F 17/30

(52) U.S. Cl. CPC G06Q 30/0204; G06F 17/30598; G06F 3/0484

(57) ABSTRACT

Processing power of a database may be leveraged to perform contact engagement analysis efficiently defining target groups. A person-centric data model allows rapid segmentation based upon details of individual contacts, and the nature of their interactions. The data model may recognize multiple facets of a single individual, for example different identifiers for various personal networks (e.g., social media networks, enterprise directories, etc.). Contact engagement analysis may use techniques such as contact classification, filtering, date period selection, and/or tag cloud based topic classification visualization, in order to achieve target group definition. A data model and UI may provide selection tools filtering data of mixed quality, allowing fast overview, and providing selection possibilities of contact groups having different data quality classifications. A tag cloud (e.g., including a time slider) shows topics of interest derived from contact interactions, thus providing visual indications. Thus, multiple contacts sharing common characteristics may be identified.

### BACKGROUND

Embodiments relate to defining target groups. Particular embodiments provide methods and apparatuses performing contact engagement analysis for target group definition.

Unless otherwise indicated herein, the approaches described in this section are not prior art to the claims in this application and are not admitted to be prior art by inclusion in this section.

Marketing efficiency may be improved by identifying receptive target groups. However, identifying such target groups becomes more difficult as relevant data quantities grow due to the extensive use of data collection tools.

One example of a data collection tool collects clickstream data each time a person visits a company homepage, so that the company can identify areas of interests of the web page contact. Other examples comprise tools directly harvesting information available in the internet, or investigating unstructured data such as emails or public/enterprise discussion forum entries.

As a result of widespread use of these and other tools, companies may receive large amounts of contact information data of mixed content, and varying marketing quality. To find new customers and to bind existing ones, companies seek to identify with specificity those persons evidencing interest in products and services sold, so as to improve data quality. Such individual contacts will agree to do business if their needs are addressed, but will generally refuse communication on the basis of blanket, generalized requests.

Large data volumes can render meaningful analysis cumbersome, time-consuming, and opaque. Slow database technology and non-intuitive user interfaces may hinder a user from meaningfully exploring and investigating contact data and creating target groups at an appropriate speed, resulting in delay until further, subsequent investigation can take place.

Accordingly, the present disclosure addresses these challenges with methods and apparatuses performing contact engagement analysis for defining target groups.

### SUMMARY

Processing power of a database may be leveraged to perform contact engagement analysis efficiently defining target groups. A person-centric data model allows rapid segmentation based upon details of individual contacts, and the nature of their interactions. The data model may recognize multiple facets of a single individual, for example different identifiers for various personal networks (e.g., social media networks, enterprise directories, etc.). Contact engagement analysis may use techniques such as contact classification, filtering, date period selection, and/or tag cloud based topic classification visualization, in order to achieve target group definition. A data model and UI may provide selection tools filtering data of mixed quality, allowing fast overview, and providing selection possibilities of contact groups having different data quality classifications. A tag cloud (e.g., including a time slider) shows topics of interest derived from contact interactions, thus providing visual indications. From the tag cloud, multiple contacts may be identified based upon their common topics of interest. Focusing upon individual needs enhances receptivity of targets to marketing efforts, taking into account individual demands, interests, and sentiments.

A computer-implemented method according to an embodiment comprises causing an analysis engine to reference a database comprising data of an item of interest in a first interaction between an individual and an entity, and a facet reflecting a first identifier of the individual in the first interaction, the facet also reflecting a second identifier of the individual in a second interaction with the entity. The method further comprises causing the analysis engine to perform a contact engagement analysis upon the data to create a contact group including the individual based upon the item of interest and the facet.

An non-transitory computer readable storage medium embodies a computer program for performing a method comprising causing an analysis engine to reference a database comprising data of an item of interest in a first interaction between an individual and an entity, and a facet reflecting a first identifier of the individual in the first interaction, the facet also reflecting a second identifier of the individual in a second interaction with the entity. The method further comprises causing the analysis engine to perform a contact engagement analysis upon the data to create a contact group including the individual based upon the item of interest and the facet.

A computer system according to an embodiment comprises one or more processors and a software program executable on said computer system. The software program is configured to cause an analysis engine to reference a database comprising data of an item of interest in a first interaction between an individual and an entity, and a facet reflecting a first identifier of the individual in the first interaction, the facet also reflecting a second identifier of the individual in a second interaction with the entity. The software program is further configured to cause the analysis engine to perform a contact engagement analysis upon the data to create a contact group including the individual based upon the item of interest and the facet.

In certain embodiments the database further comprises data provided to the database from an external source, and the analysis engine creates the target group based upon the data provided from the external source.

According to some embodiments the analysis engine creates the target group based upon a filter criterion input by a user.

Particular embodiments may further comprise causing the analysis engine to communicate the target group for display on a dashboard.

In various embodiments the dashboard comprises a tag cloud.

According to certain embodiments the dashboard comprises a time adjustment feature.

In particular embodiments the dashboard comprises a sentiments gauge.

The following detailed description and accompanying drawings provide a better understanding of the nature and advantages of particular embodiments.

### BRIEF DESCRIPTION OF THE DRAWINGS

FIG. 1 shows a simplified view of a system according to an embodiment.

FIG. 2 shows a general view of the flow of different types of contact information within a system.

FIG. 3 depicts one particular example of a database storing data useful in contact engagement analysis.

FIG. 4 is a simplified flow diagram showing steps of a method according to an embodiment.

FIG. 5 shows a Remote Function Call (RFC) module used in contact evaluation according to an embodiment.

FIG. 6 shows an import data structure according to an embodiment.

FIG. 7 shows an overview of a dashboard displaying various views showing the results of contact engagement performed according to the example. FIGS. 7A-C show details of certain views.

FIG. 8 is a simplified view showing loading of data into the inbound tables for further processing.

FIG. 9 illustrates hardware of a special purpose computing machine configured to conduct contact engagement analysis for target group definition.

FIG. 10 illustrates an example of a computer system.

### DETAILED DESCRIPTION

Described herein are techniques allowing contact engagement analysis for target group definition. The apparatuses, methods, and techniques described below may be implemented as a computer program (software) executing on one or more computers. The computer program may further be stored on a computer readable medium. The computer readable medium may include instructions for performing the processes described below.

In the following description, for purposes of explanation, numerous examples and specific details are set forth in order to provide a thorough understanding. It will be evident, however, to one skilled in the art that embodiments as defined by the claims may include some or all of the features in these examples alone or in combination with other features described below, and may further include modifications and equivalents of the features and concepts described herein.

In general, contact engagement allows an entity to consolidate and analyze information about contacts—known or unknown persons who have interacted with the entity. Contact engagement assesses the different types interactions by the contacts, including but not limited to: actual, previous contact (e.g., as a customer or client); physical participation in an event; telemarketing via call centers; and virtual, anonymous, or public postings in social media.

By grouping related types of interactions, an entity may identify relevant channels. Such channels can include but are not limited to: web (e.g., clickstream on a web page), social media (e.g., postings on FACEBOOK®/TWITTER®/etc. . . . ), real life events (e.g., summits, business gatherings, . . . ), texts, emails, or telephone calls. These are merely some examples of channels, and an entity could utilize particular embodiments as described herein to define its own relevant channels.

Per channel, a called facet may be defined. A facet recognizes different aspects of a single person, for example the separate discrete identifiers a specific individual may have on various personal networks (e.g., public social networks such as FACEBOOK® and TWITTER®, or private internal networks such as enterprise directories). Facets and channels may be combined into a contact. The “golden record” of such a contact represents the most complete, up-to-date information for a particular individual, including various facets thereof.

Independent of channel, one or more topics of interest per interaction may be defined. As discussed below, these topics of interest may be presented for visualization in the form of a tag cloud.

Embodiments allow observation of the contact population using flexible configurable filter criteria. Examples of such filter criteria can include but are not limited to topics of interest, geography, past history (education, employment).

Using this approach, an entity may decide to focus upon and address a certain group with marketing efforts. This can bring the target group closer to dealing with the entity, thereby practically nurturing a target group of contacts.

Specific embodiments may thus harness the processing power of a database to perform contact engagement analysis efficiently defining target groups. A person-centric data model allows rapid segmentation based upon details of individual contacts, and the nature of their interactions. The data model may recognize multiple facets of a single individual, for example different identifiers for various personal networks (e.g., social media networks, enterprise directories, etc.). Contact engagement analysis may use techniques such as contact classification, filtering, date period selection, and/or tag cloud based topic classification visualization, in order to achieve target group definition. A tag cloud (e.g., including a time slider) shows topics of interest derived from contact interactions, thus providing visual indications. From the tag cloud, multiple contacts may be identified based upon their common topics of interest. Focusing upon individual needs enhances receptivity of targets to marketing efforts, taking into account individual demands, interests, and sentiments.

Embodiments may provide data model(s) and a user interface offering fast and easy-to-use selection tools allowing filtering of data with mixed data quality. Embodiments may permit rapid overview and selection possibility of contact person groups with different data quality classification, together with an overview on created mentions (like entries in social media) and a corresponding average sentiment.

A feature of certain embodiments is the use of a tag cloud to show topics of interest, that are derived from the contacts' interactions. This tag could furnish a visual indication of a number of contacts to whom a particular topic of interest is important.

A time adjustment feature (e.g., slider, dial, or other) may afford a user intuitive insight into the time-related evolution of topics of interest. In certain embodiments a user's changing a time slider or other filter criteria, may influence the tag cloud display. For example, only topics of interest for selected contacts in the selected time frame may be displayed after a selection change.

From the tag cloud, groups of contacts can be selected by selecting their common topic of interest. Based on one or many selected topics of interest, a target group can be created to effect highly efficient marketing activities tailored to customer interests.

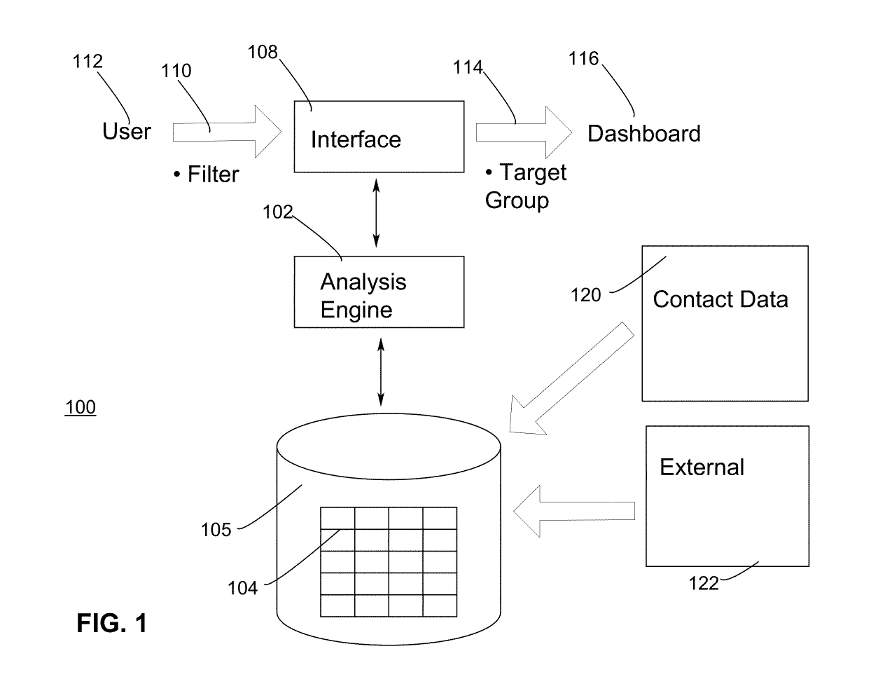

FIG. 1 shows a simplified view of a system according to an embodiment. In particular, system 100 comprises an analysis engine 102 that is in communication with a database 104 stored on a non-transitory computer readable storage medium 105.

The database has stored thereon, contact data relevant to contacts between individual(s) and an entity (e.g., a business). This contact data may be received from a data source 120.

The database may also have stored thereon, additional data relevant to the contact data, received from an external source 122. Various examples of such external sources are described below, and may include but are not limited to:
business applications, e.g., Enterprise Resource Planning (ERP) or Customer Relationship Management (CRM);
applications for clickstream monitoring and/or email campaign execution;
social network information harvesting applications;
sentiment gauging applications.

The engine may process the data stored in the database, in order to perform contact engagement analysis. In certain embodiments, the engine may also serve to receive, populate, and/or update the database with relevant data received from the various sources.

FIG. 1 thus shows the engine as being in communication with an interface 108. This interface is configured to receive inputs 110 (e.g., filter criteria) from a user 112, and to produce corresponding outputs 114 comprising a target group. These outputs which may be presented to the user in the form of a dashboard 116. As described in detail below, the dashboard may present results in the form of tag clouds and other visual displays.

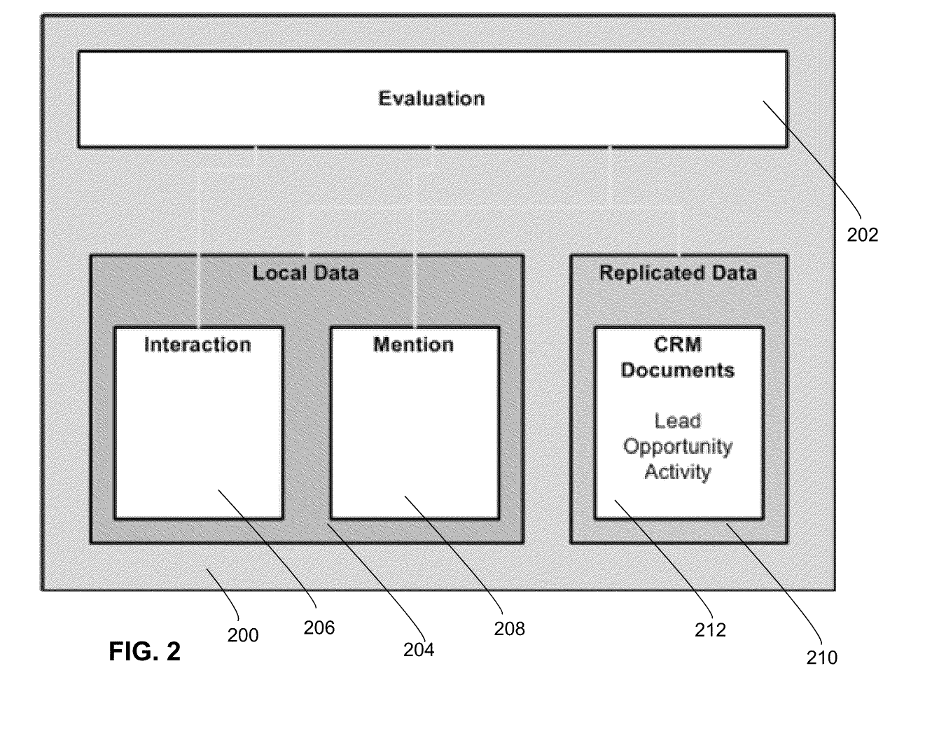

FIG. 2 shows a general view of the flow 200 of different types of contact information within the system. In particular the analysis engine may receive for evaluation 202, local data 204 comprising interactions 206 and mentions 208.

The analysis engine may also receive for evaluation, replicated data 210 such as business documents. One source of such replicated data may be Customer Relationship Management (CRM) software 212, providing lead, opportunity, and activity information.

Together, such information forms the basis for contact engagement analysis of interactions according to embodiments. Such interactions may be structured to indicate features of a contact such as:
who (e.g., contact attributes);
what (e.g., interaction type);
how (e.g., communication medium);
why (e.g., item of interest);
when (e.g., time stamp).

According to particular embodiments, data from the database may be organized into various data structures (e.g., data objects). Examples of such data structures can comprise data including but not limited to:
account information (e.g., name, geographical region, internal organization, etc.);
individual contact information (e.g., contact first and last names, contact title, contact industry, contact department, contact function, contact address, contact geographic location, contact gender, contact email, etc.);
interaction information (e.g., timestamp, communication medium, item of interest), interaction attributes (e.g., relevant marketing campaign ID, quantifier(s), valuation, etc.), and contact facet attributes (e.g., contact name, contact language, contact gender, personal network identifiers, business cards, etc.);
channel information (e.g., channel, description, type).

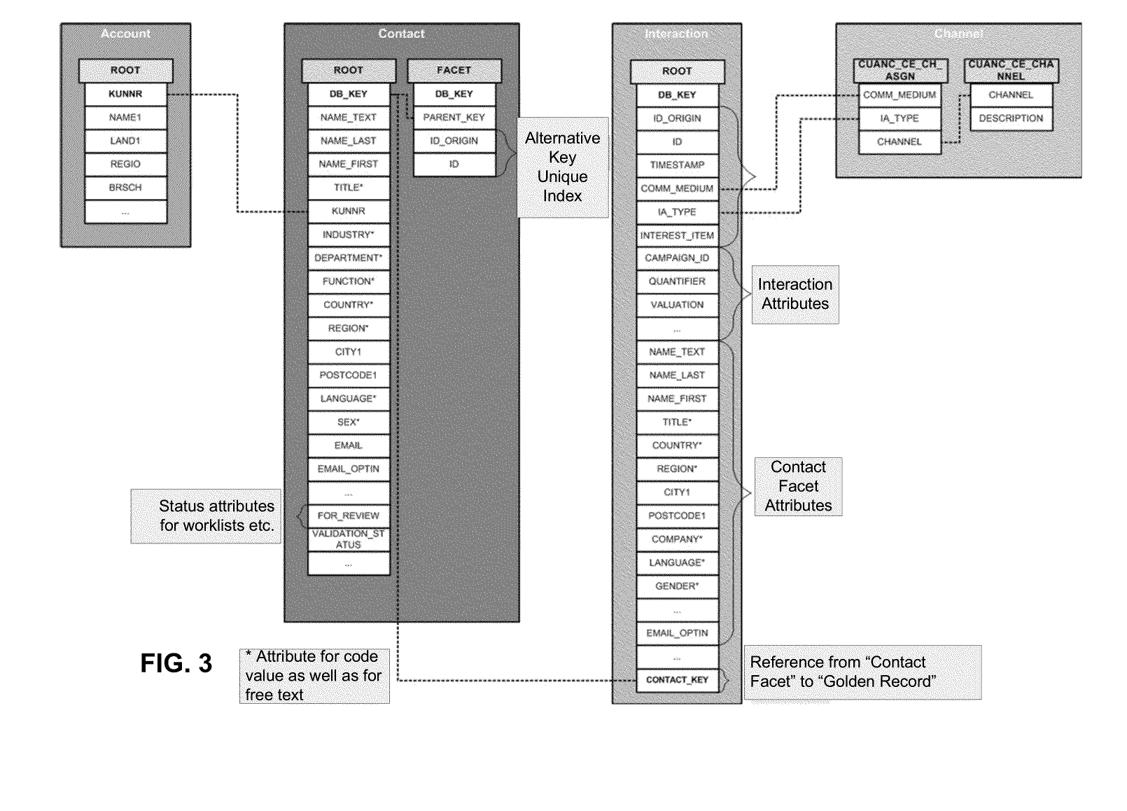

FIG. 3 below depicts one particular example of fields in a database storing data useful in contact engagement analysis. FIG. 3 also shows the organization of this data according to various data objects, which may have one or more data fields in common. FIG. 3 is discussed further below in connection with a specific example.

Returning to FIG. 1, certain embodiments may further interact with one or more external systems 120, 122 in order to receive and store data. Examples of such external systems may include but are not limited to those performing clickstream monitoring and/or email campaign execution. Another example of such a system is an external data provider responsible for harvesting relevant information from social networks such as FACEBOOK® or TWITTER®. Data from such external systems may be stored in the database to provide the user a holistic basis for viewing and evaluating the collected data. Still another example of such an external system may be a business system (e.g., CRM) including business documents from which additional data may be extracted.

The analysis engine 102 is further in communication with an interface 108 to receive input(s) 110 from a user 112. These user inputs may define certain relevant parameters such as filters to be applied, and/or the manner of displaying relevant output 114 from the analysis engine to be displayed.

As is described further in connection with the following specific example, according to certain embodiments the output of the engine may comprise the results of contact engagement analysis in the form of a dashboard 116 displaying a panel for contact information, a tag cloud, and filter specifics.

While FIG. 1 shows the analysis engine as outside the database, this is not required. Certain embodiments may leverage the processing power of a database engine in order to perform contact engagement analysis tasks.

The high processing power of an in-memory database engine may be particularly suited for this purpose. One example of such an in-memory database is the HANA database available from SAP AG of Walldorf, Germany. Other examples in-memory databases include the SYBASE IQ database also available from SAP AG; the Microsoft Embedded SQL for C (ESQL/C) database available from Microsoft Corp. of Redmond, Wash.; and the Exalytics In-Memory database available from Oracle Corp. of Redwood Shores, Calif.

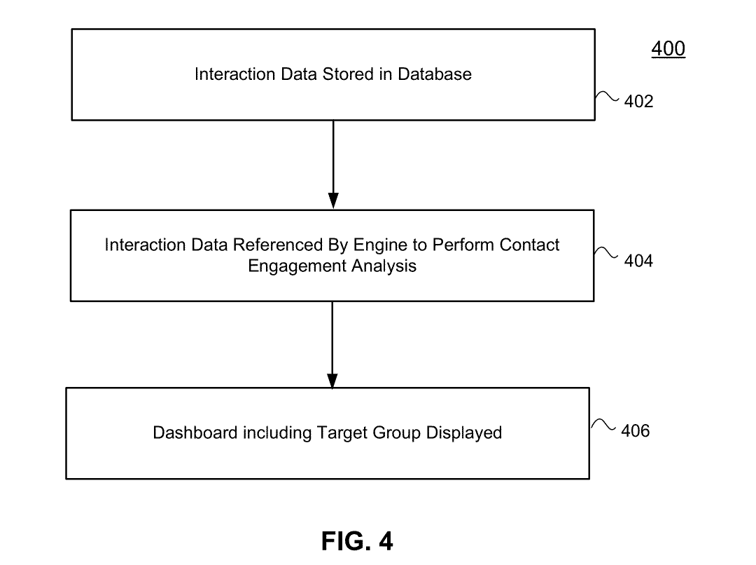

FIG. 4 is a simplified flow diagram showing steps of a method 400 according to an embodiment. In a first step 402, a database comprising data of an interaction between an individual and an entity is provided. In a second step 404, an engine references this data in order to perform contact engagement analysis reflecting membership of the individual in a target group. In a third step 406, the engine is caused to communicate the target group to a user via a dashboard.

Details regarding one particular embodiment of contact engagement analysis, are now presented below in connection with the following example.

### EXAMPLE

One particular example is now described in conjunction with the HANA in-memory database available from SAP AG of Walldorf, Germany. FIG. 3 described above, shows the structure of the database and of data objects.

FIG. 3 shows that contact data of the underlying database may be organized into various different data objects to provide useful contact evaluation analysis. Examples of such different data objects include “Account”, reflecting an individual's affiliation with a specific client or customer, in a particular region. Other data objects organize data according to “Contact”, “Interaction”, and “Channel”.

In particular, the “Contact” data object includes a FACET node. As previously mentioned, such a facet can link multiple identifiers (e.g., for different personal networks) implicated by different contacts between the same individual and the entity.

Also specifically shown in FIG. 3, is the “INTEREST_ITEM” field of the “Interaction” data object. This field tracks a particular subject in which the individual may have expressed an interest. In certain embodiments, this field may be affiliated with a product or service being marketed to the target group. Thus where contact information reveals an individual's expressed interest in a particular type of automobile, the “INTEREST_ITEM” field could be filled with the model or manufacturer of an automobile that is the subject of marketing efforts.

While FIG. 3 shows a single interest item field, this is not required and multiple interest item fields may be employed to reflect a plurality of valuable interests evidenced by an individual contact. The searchability of such interest item fields using key words, may offer significantly enhanced accuracy to targeted marketing efforts.

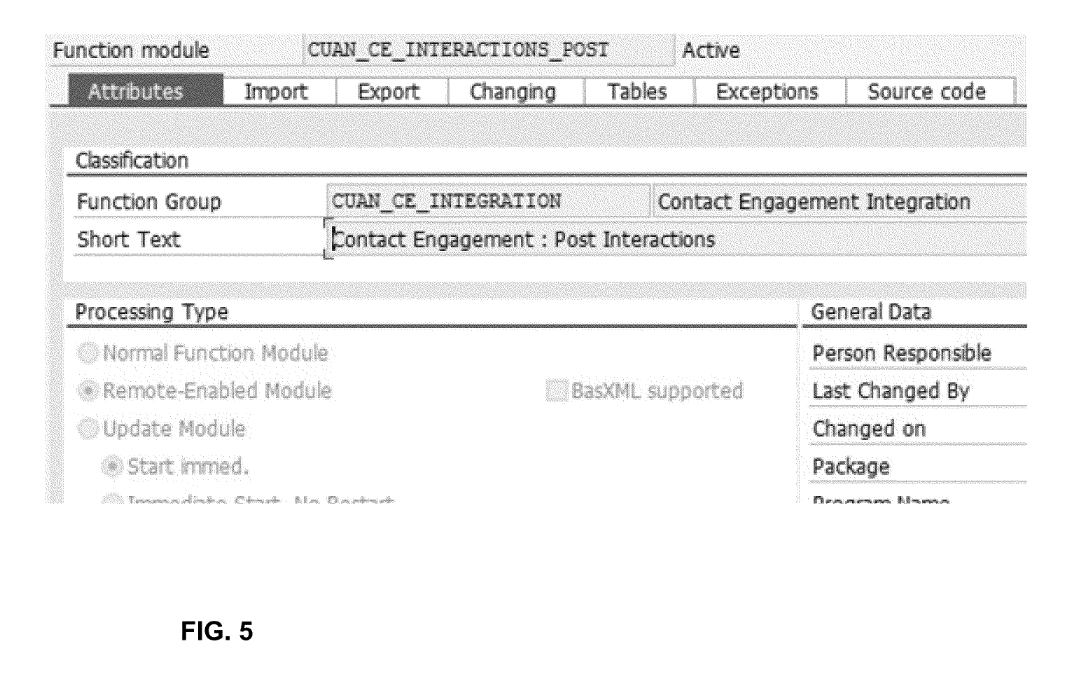

Interactions may be pushed to the analysis engine configured to perform evaluation (referred to herein as “Social Contact Intelligence”) using a Remote Function Call (RFC) module titled CUAN_CE_INTERACTIONS_POST. FIG. 5 shows details of this module.

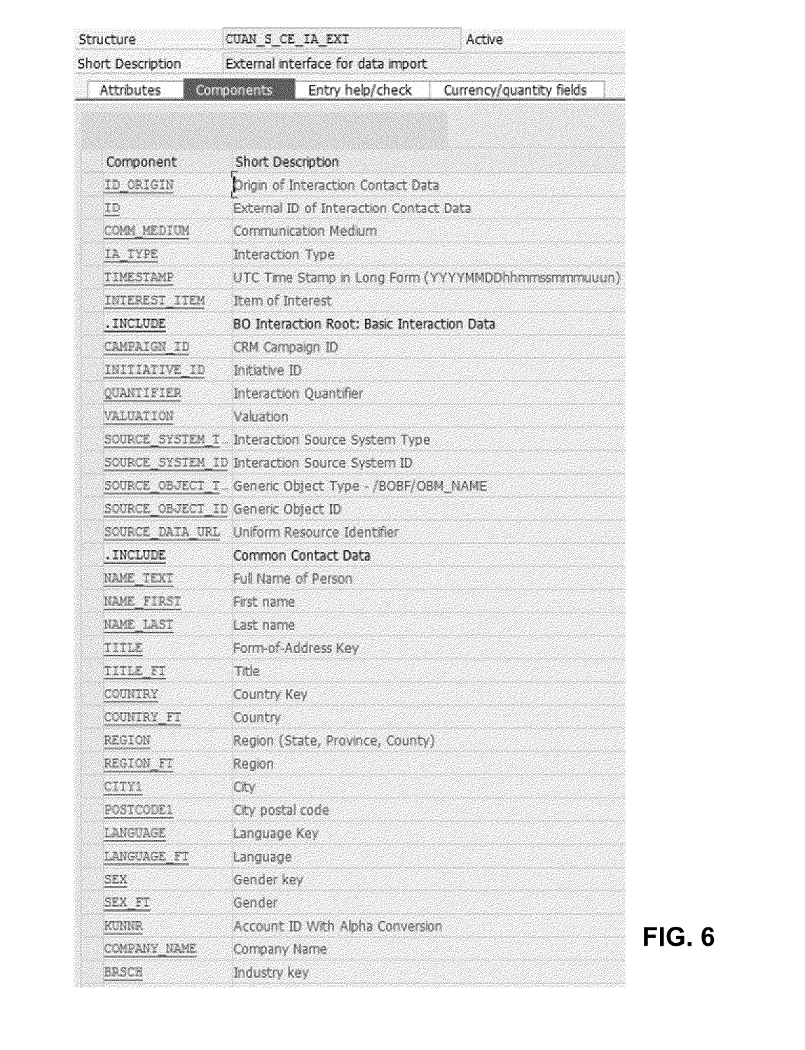

An import data structure CUAN_S_CE_IA_EXT is shown in FIG. 6. This import data structure includes interaction information, contact information, and an extension.

The import data structure CUAN_S_CE_IA_EXT of FIG. 6 also includes attributes for codes, as well as free text. Examples are COUNTRY and COUNTRY_FT.

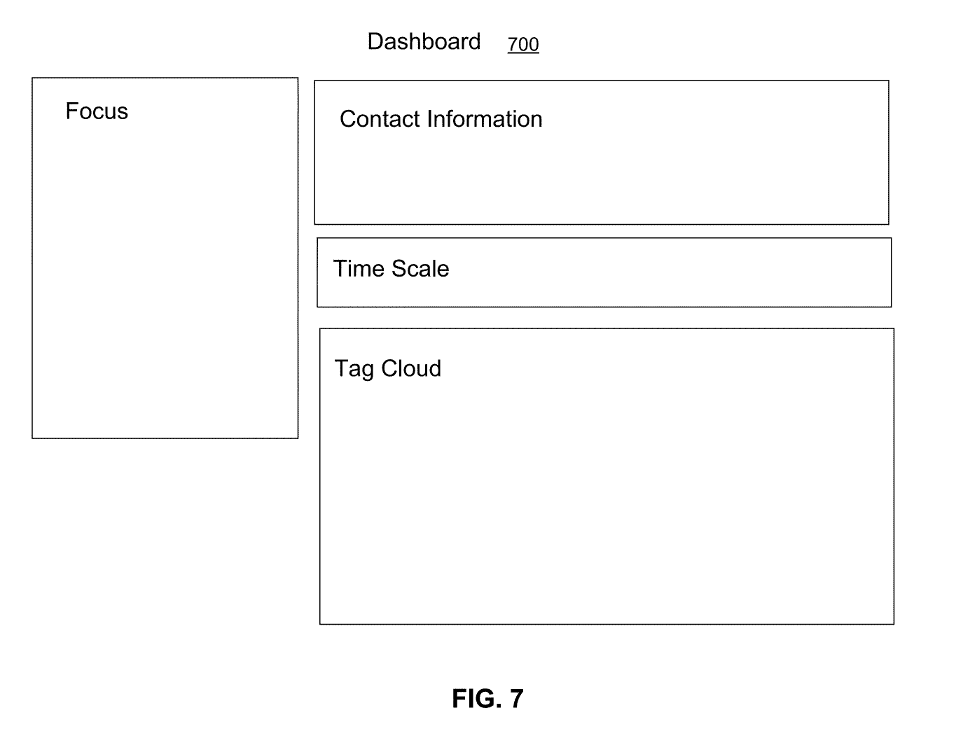

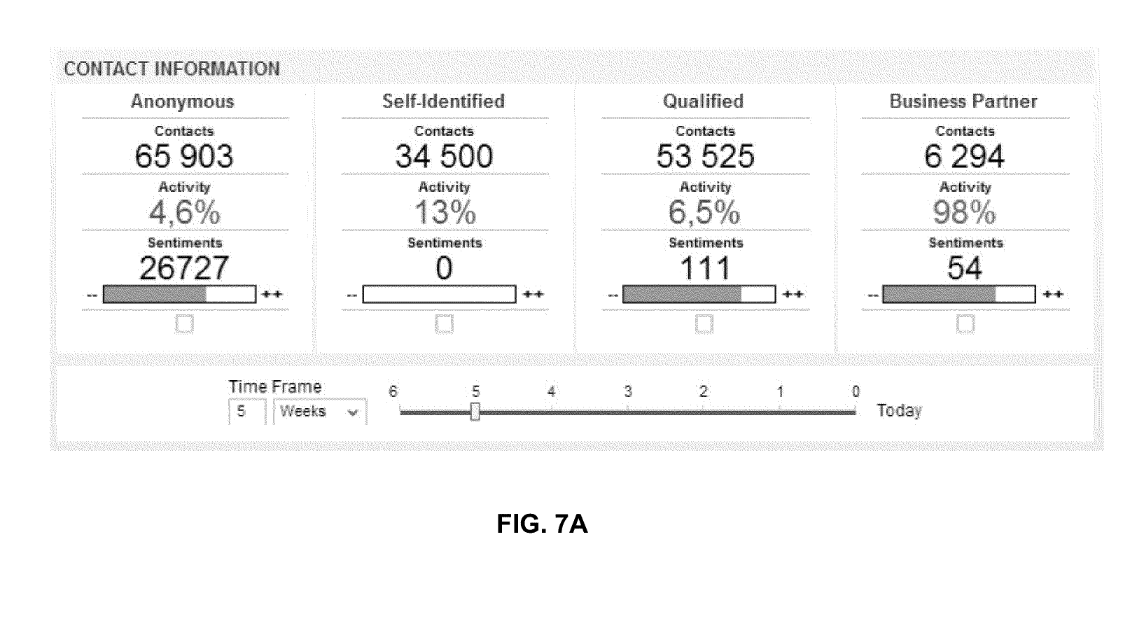

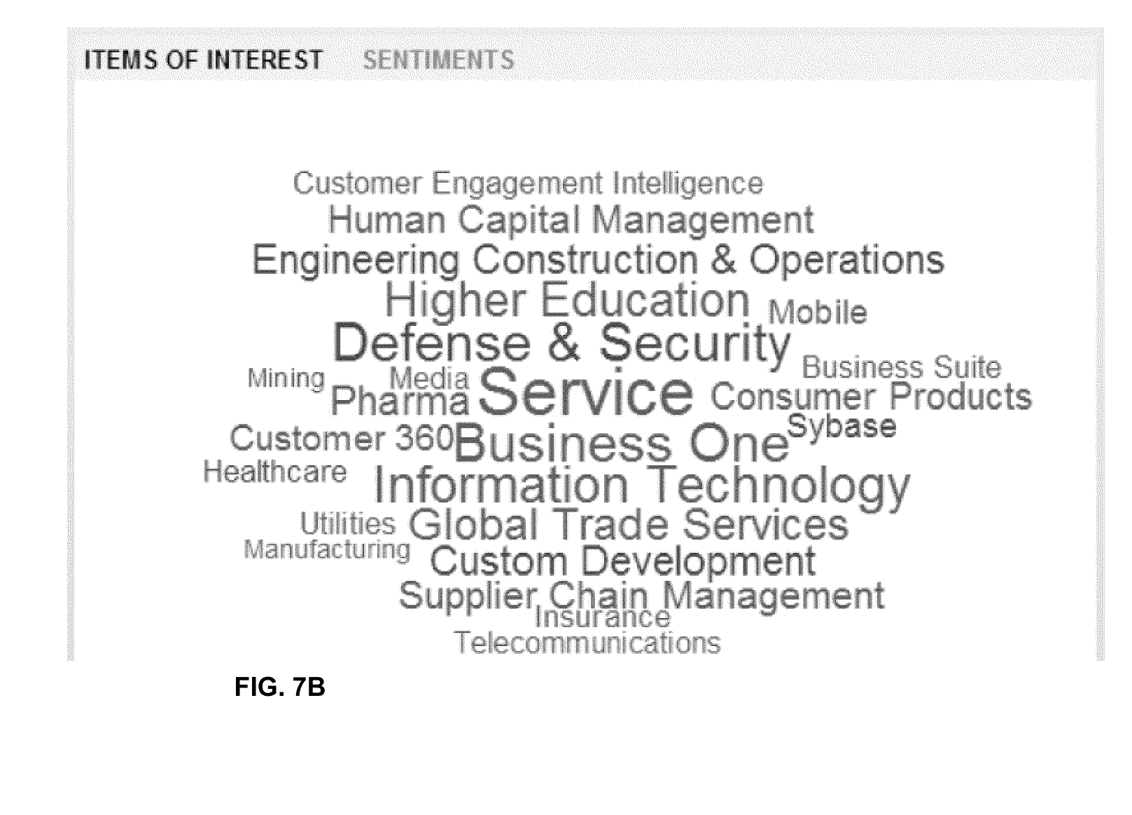

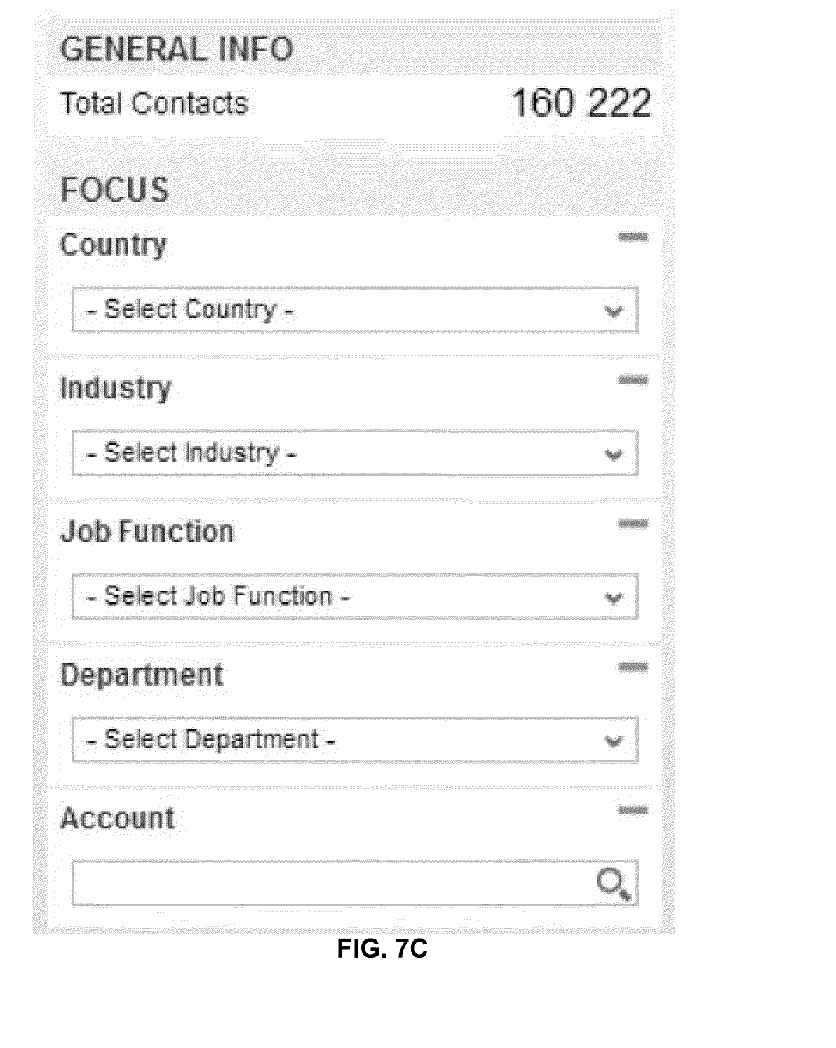

FIG. 7 shows an overview of a dashboard displaying various views showing the results of contact engagement performed according to the example. In particular, the dashboard 700 comprises a contact view, a time scale, a tag cloud, and a focus view.

The contact view and time ruler are enlarged in FIG. 7A. In particular, the time ruler shows the contact universe, based on a contact level. This panel shows from left to right, how close the contacts are to sales activity.

This panel also shows how many of the contacts had an interaction in the last time period. That time period (here set to five weeks), is maintained with the time ruler.

The sentiments gauge shows how many posts/texts in that particular period came in from these contacts. The content of the posts/texts can be automatically interpreted regarding their positiveness, from very positive (++) to very negative (−−).

FIG. 7B shows the tag cloud with the items of interest. The size of the item shows how many interactions in the time period maintained in the time ruler, came in from the filtered contacts.

Items can be selected, and then the contacts that are the subject of the interaction are added automatically to a new target group. The interactions can be tagged/related with an item of interest. In FIG. 7B, the web download can be tagged with a term (e.g., SAP CRM) which is the item of interest shown here.

FIG. 7C shows a filter allowing focusing of the contacts. Such focus filters determine what is shown in the contact information and the related interactions.

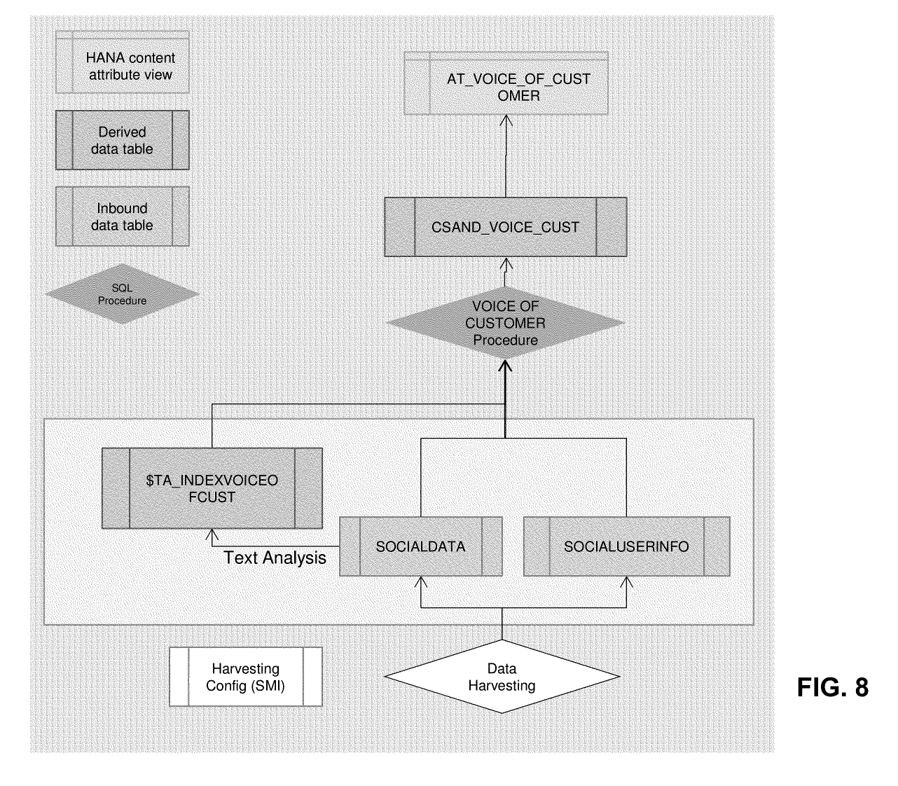

Data can be harvested from public social media or internal sources (e.g., enterprise directories, intranets). It may be loaded into the inbound tables for further processing, as shown in FIG. 8.

In particular, one of the following options may be chosen. A first option is to implement own data crawling logic. One example is to use script language to access provider Application Program Interfaces (APIs), and pass data via Open DataBase Connectivity (ODBC) into HANA inbound tables.

A second option is to use example connectors of Social Contact Intelligence based on SAP Business Objects Data Services to access FACEBOOK® or TWITTER® data that has been harvested by an external data provider. One example of such an external data provider is DATASIFT® available from NETBASE® of Mountain View, Calif.

A third option is the use of consulting support provided by the Rapid Deployment Solution (RDS) Sentiment Intelligence available from SAP AG. The RDS also uses SAP Business Objects Data Services.

It is noted that interaction contacts may be created from interactions irrespective of their source. To ensure that only one interaction contact per one natural person is created, the system may identify an already existing matching interaction contact.

Embodiments may allow a user to influence the search result implementing a corresponding business add in, for example the BAdI offered by SAP AG. Every new interaction can improve a data quality of interaction contacts. A user can influence how existing data is changed by new interactions, utilizing such a BAdI.

For example, a user can identify which source of information takes priority in providing up-to-date information in the database. Thus where a FACEBOOK® search indicates the recent marriage of an individual, this marital status update may take priority over extant information from another source (e.g., CRM software) not yet reflecting the marriage. Such an event can in turn trigger updating of other database information, for example the married name of the individual contact.

A user can define how much data is considered to determine interaction contact attributes. A user can periodically apply changes of business partner or contact person data to their corresponding interaction contacts via report CUAN_IC_MASTERDATA_EXTR.

A user can extract CRM business partner data and ERP contact person data, via full upload after system set-up. A delta upload may be scheduled for periodic checking for changes.

Various embodiments can provide one or more of the following benefits. One potential benefit is rapidity of processing by reliance upon the processing power of a fast database. This aspect is particularly represented where an in-memory database engine performs the contact analysis.

Storing data relating to individual people organized into appropriate data objects, shifts the emphasis to personal contact rather than more impersonal account contacts. This allows focusing on a person's topic(s) of interest, rather than an account's marketing characteristics, as basis for the selection of a target group.

A multi-faceted/multi-channel analysis of contacts may be possible. This reveals if/how a contact potentially interacts in several ways with the entity (e.g., via FACEBOOK®, via TWITTER®, via a business conference, via a call center, etc.). Recognition of such facets of an individual can consolidate valuable business insights for recognition and action.

Embodiments may allow the nurturing of contacts by collecting data in different channels and enriching the single contact in his value for the business. Moreover, this may be done via an easy-to-use user interface with fast response on user interactions. Such an interface may allow the user to select configurable and adaptable channels, contact levels, filters, and interests, thereby serving business marketing needs.

Finally, particular embodiments may be readily integrated with existing CRM systems. This is particularly true for out of the box integration with in-house CRM Systems available from SAP AG.

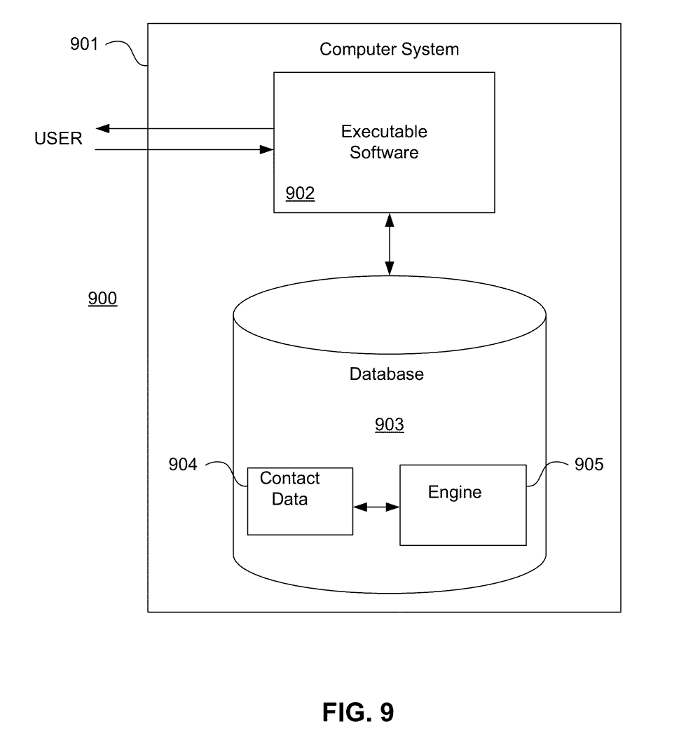

FIG. 9 illustrates hardware of a special purpose computing machine configured to perform contact engagement analysis according to an embodiment. In particular, computer system 901 comprises a processor 902 that is in electronic communication with a non-transitory computer-readable storage medium 903. This computer-readable storage medium has stored thereon code 905 corresponding to an analysis engine. Code 904 corresponds to contact data. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

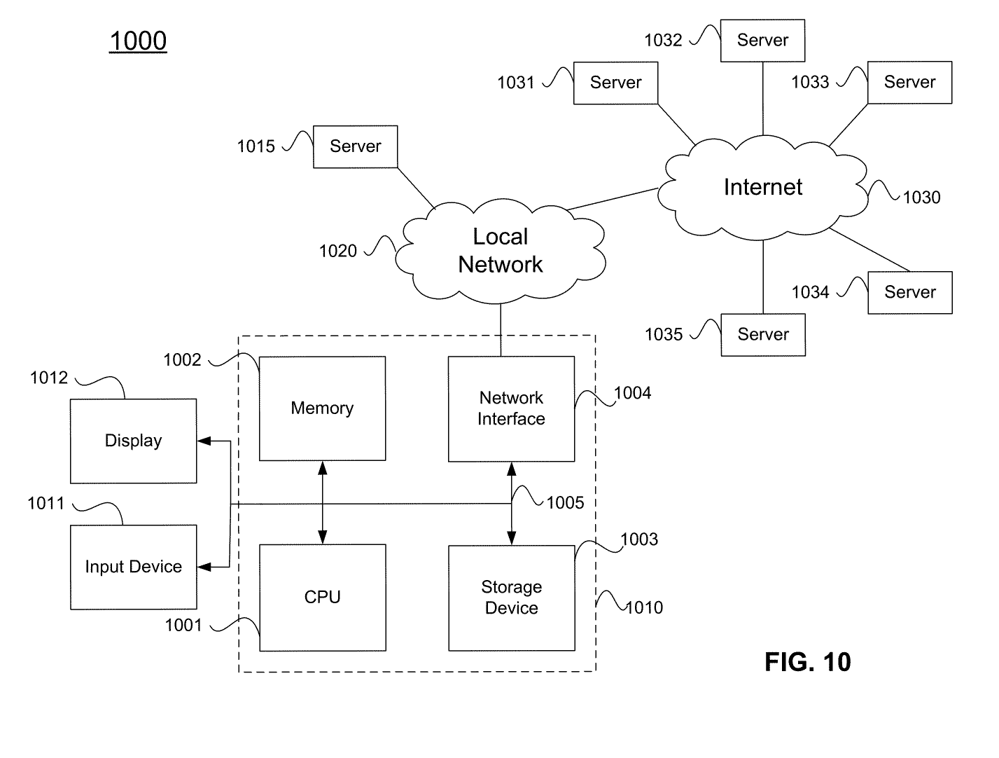

An example computer system 1010 is illustrated in FIG. 10. Computer system 1010 includes a bus 1005 or other communication mechanism for communicating information, and a processor 1001 coupled with bus 1005 for processing information. Computer system 1010 also includes a memory 1002 coupled to bus 1005 for storing information and instructions to be executed by processor 1001, including information and instructions for performing the techniques described above, for example. This memory may also be used for storing variables or other intermediate information during execution of instructions to be executed by processor 1001. Possible implementations of this memory may be, but are not limited to, random access memory (RAM), read only memory (ROM), or both. A storage device 1003 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1003 may include source code, binary code, or software files for performing the techniques above, for example. Storage device and memory are both examples of computer readable mediums.

Computer system 1010 may be coupled via bus 1005 to a display 1012, such as a cathode ray tube (CRT) or liquid crystal display (LCD), for displaying information to a computer user. An input device 1011 such as a keyboard and/or mouse is coupled to bus 1005 for communicating information and command selections from the user to processor 1001. The combination of these components allows the user to communicate with the system. In some systems, bus 1005 may be divided into multiple specialized buses.

Computer system 1010 also includes a network interface 1004 coupled with bus 1005. Network interface 1004 may provide two-way data communication between computer system 1010 and the local network 1020. The network interface 1004 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1004 sends and receives electrical, electromagnetic, or optical signals that carry digital data streams representing various types of information.

Computer system 1010 can send and receive information, including messages or other interface actions, through the network interface 1004 across a local network 1020, an Intranet, or the Internet 1030. For a local network, computer system 1010 may communicate with a plurality of other computer machines, such as server 1015. Accordingly, computer system 1010 and server computer systems represented by server 1015 may form a cloud computing network, which may be programmed with processes described herein. In the Internet example, software components or services may reside on multiple different computer systems 1010 or servers 1031-1035 across the network. The processes described above may be implemented on one or more servers, for example. A server 1031 may transmit actions or messages from one component, through Internet 1030, local network 1020, and network interface 1004 to a component on computer system 1010. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
causing an analysis engine to reference a database comprising,
data of an item of interest in a first interaction between an individual and an entity, and
a facet reflecting a first identifier of the individual in the first interaction, the facet also reflecting a second identifier of the individual in a second interaction with the entity; and
causing the analysis engine to perform a contact engagement analysis upon the data to create a contact group including the individual based upon the item of interest and the facet.

2. A method as in claim 1 wherein the database further comprises data provided to the database from an external source, and the analysis engine creates the target group based upon the data provided from the external source.

3. A method as in claim 1 wherein the analysis engine creates the target group based upon a filter criterion input by a user.

4. A method as in claim 1 further comprising causing the analysis engine to communicate the target group for display on a dashboard.

5. A method as in claim 4 wherein the dashboard comprises a tag cloud.

6. A method as in claim 4 wherein the dashboard comprises a time adjustment feature.

7. A method as in claim 4 wherein the dashboard comprises a sentiments gauge.

8. A non-transitory computer readable storage medium embodying a computer program for performing a method, said method comprising:
causing an analysis engine to reference a database comprising,
data of an item of interest in a first interaction between an individual and an entity, and
a facet reflecting a first identifier of the individual in the first interaction, the facet also reflecting a second identifier of the individual in a second interaction with the entity; and
causing the analysis engine to perform a contact engagement analysis upon the data to create a contact group including the individual based upon the item of interest and the facet.

9. A non-transitory computer readable storage medium as in claim 8 wherein the database further comprises data provided to the database from an external source, and the analysis engine creates the target group based upon the data provided from the external source.

10. A non-transitory computer readable storage medium as in claim 8 wherein the analysis engine creates the target group based upon a filter criterion input by a user.

11. A non-transitory computer readable storage medium as in claim 8 wherein the method further comprises causing the analysis engine to communicate the target group for display on a dashboard.

12. A non-transitory computer readable storage medium as in claim 11 wherein the dashboard comprises a tag cloud.

13. A non-transitory computer readable storage medium as in claim 11 wherein the dashboard comprises a time adjustment feature.

14. A non-transitory computer readable storage medium as in claim 11 wherein the dashboard comprises a sentiments gauge.

15. A computer system comprising:
one or more processors;
a software program, executable on said computer system, the software program configured to:
cause an analysis engine to reference a database comprising,
data of an item of interest in a first interaction between an individual and an entity, and
a facet reflecting a first identifier of the individual in the first interaction, the facet also reflecting a second identifier of the individual in a second interaction with the entity; and
cause the analysis engine to perform a contact engagement analysis upon the data to create a contact group including the individual based upon the item of interest and the facet.

16. A computer system as in claim 15 wherein the database further comprises data provided to the database from an external source, and the analysis engine creates the target group based upon the data provided from the external source.

17. A computer system as in claim 15 wherein the analysis engine creates the target group based upon a filter criterion input by a user.

18. A computer system as in claim 15 wherein the analysis engine is further caused to communicate the target group for display on a dashboard.

19. A computer system as in claim 18 wherein the dashboard comprises a tag cloud.

20. A computer system as in claim 18 wherein the dashboard comprises a time adjustment feature.
